(19) United States
(12) Patent Application Publication
(10) Pub. No.: US 2009/0199980 A1
(43) Pub. Date: Aug. 13, 2009

(54) Light restricting system and method

(76) Inventor: Matthew Watford, Darlington, SC (US)

Correspondence Address: MCNAIR LAW FIRM, P.A., P.O. BOX 447, GREENVILLE, SC, 29602-0447, US

(21) Appl. No.: 12/384,733

(22) Filed: Apr. 9, 2009

Related U.S. Application Data
(62) Division of application No. 11/455,595, filed on Jun. 19, 2006.

(51) Int. Cl. E06B 9/24; E06B 9/00

(52) U.S. Cl. 160/368.1; 160/405

(57) ABSTRACT

This invention is directed to an apparatus and method for restricting light from entering through a window's structure. An opaque cloth is secured by a plurality of flexible securing members. The securing members are held in place by flexible securing members to secure the opaque cloth in the window. The opaque cloth can include perimeter portions which help restrict light from leaking around the edges of the opaque cloth. This invention also includes the method for restricting light using an opaque cloth and flexible securing members.

### CROSS-REFERENCE TO RELATED APPLICATION

This application is a division of and claims priority from U.S. application Ser. No. 11/455,595, filed Jun. 19, 2006.

### FIELD OF THE INVENTION

This invention is directed to a system and method for restricting light from entering through a structure's window.

### BACKGROUND OF THE INVENTION

Typically, society operates on a schedule which focuses its activity during day light hours and sleep during the night. It is believed that these behavior patterns are a product of both necessity and instinct. Simply, most activities are benefited by the existence of daylight while sleep is facilitated by night. However, the industrial revolution, military, entertainment (such as casinos), and other such activities have popularized the “third shift” to increase productivity by allowing factories, businesses, plants, the military and other entities to operate “around-the-clock”. There are also many other instances where the desire to restrict sunlight is desirous. For example, part time photographic labs, projections for presentations, movies, or other needs. One effect of third shift, however, is to create the need for individuals to sleep during day light hours.

Many individuals who operate on the third shift schedule can experience difficulty with sunlight entering the window of structures thereby disrupting the individuals' sleep. Attempts to prevent sunlight from entering a room has met with mixed success. For example, blinds and shutters are not completely effective in blocking light. Blinds and shades require installation which can require drilling, mounts, screws and other potentially undesirable consequences which accompany installation. Curtains and other coverings also suffer from the disadvantages of not being completely effective and require mounting or mounting hardware.

Further, the use of curtains, blinds, shades or other similar means can be expensive and since they are permanent, need to be coordinated with the rooms decor.

Therefore, there is a need for an inexpensive, easily installable and removable apparatus and method for preventing sunlight from entering a room.

### SUMMARY OF THE INVENTION

This invention is directed to a method and system for restricting light from entering through a structure's window comprising the steps of providing an opaque cloth having a length longer than the height of the window and a width larger than the width of the window; the opaque cloth having a first and second top corner and corresponding diagonally opposite bottom corners; placing the first top corner of the opaque cloth into a first top corner of the window so that a portion of the perimeter of the opaque cloth is disposed adjacent to a first interior wall of the window, thereby restricting light from around the opaque cloth; placing the first end of the first flexible securing member against the opaque cloth and into the first top corner of the window so that the opaque cloth is secured into the first top corner of the window; placing the second end of the first flexible securing member against the opaque cloth and against the diagonally opposite side to the first top corner of the window so that the opaque cloth is secured against the side of the window; placing the second top corner of the opaque cloth into a second top corner of the window so that a portion of the perimeter of the opaque cloth is disposed adjacent to a second interior wall of the window and the top wall of the window, thereby restricting light from leaking around the opaque cloth; placing the first end of the second flexible securing member against the opaque cloth and into the second top corner of the window so that the opaque cloth is secured into the second top corner of the window; and placing the second end of the second flexible securing member against the opaque cloth and against the diagonally opposite side to the second top corner of the window so that the opaque cloth is secured against the side of the window.

Further, this invention can include the steps of placing a first bottom corner of the opaque cloth in the diagonally opposite bottom corner of the window to the first top corner of the window; the step of placing the second end of the first flexible securing member against the opaque cloth and against the diagonally opposite side includes the step of placing the second end of the first flexible securing member into the diagonally opposite bottom corner of the window to the first top corner of the window; placing a second bottom corner of the opaque cloth in the diagonally opposite bottom corner of the window to the second top corner of the window; and, the step of placing the second end of the second flexible securing member against the opaque cloth and against the diagonally opposite side includes the step of placing the second end of the second flexible securing member into the diagonally opposite bottom corner of the window to the second top corner of the window.

The window can contain a top sash and a bottom sash and include the step of placing the second end of the first flexible securing member against the opaque cloth and against the diagonally opposite side includes placing the second end of the first flexible securing member against the opaque cloth and into a first corner formed by the top sash and the bottom sash; and the step of placing the second end of the second flexible securing member against the opaque cloth and against the diagonally opposite side includes placing the second end of the second flexible securing member against the opaque cloth and into a second corner formed by the top sash and the bottom sash.

Further, this invention can include the steps of providing a third flexible securing member having a first end and a second end; placing a first bottom corner of the opaque cloth into a first diagonally opposite corner to the first top corner of the window; placing the first end of the third flexible securing member against the first bottom corner of the opaque cloth and into the first diagonally opposite corner; placing a second bottom corner of the opaque cloth into a second diagonally opposite corner to the second top corner of the window; placing the second end of the third flexible securing member against the second bottom corner of the opaque cloth and into the second diagonally opposite corner so that the third securing member secures the bottom corners of the opaque cloth to the window.

Further, the step of providing an opaque cloth can include the step of providing an opaque cloth having a first pocket carried by the first top corner for receiving the first end of the first flexible securing member and a second pocket carried by the second top corner for receiving the first end of the second flexible securing member; placing the first end of the first flexible securing member into the first pocket; and placing the first end of the second flexible securing member into the second pocket.

Further, this invention can include the steps of connecting the first end of the first flexible securing member to the second end of the first flexible securing member so that the length of the flexible securing member is larger than the diagonal length of the window; and, connecting the first end of the second flexible securing member to the second end of the second flexible securing member so that the length of the flexible securing members are larger than the diagonal length of the window.

This invention can include an opaque cloth having a length longer than the height of the window and a width larger than the width of the window; a first flexible securing member for securing the top-left corner of the opaque cloth in the top-left corner of the window and securing the diagonally opposite side of the opaque cloth to the diagonally opposite side of the window; and, a second flexible securing member for securing the top-right corner of the opaque cloth in the top-right corner of the window and securing the diagonally opposite side of the opaque cloth to the diagonally opposite side of the window.

This invention can include a first pocket carried by the top-left corner of the opaque cloth for receiving an end of the first flexible securing member for securing the opaque cloth to the window; and a second pocket carried by the top-right corner of the opaque cloth for receiving an end of the second flexible securing member for securing the opaque cloth over the window.

This invention can include a top portion carried by the opaque cloth so that when the top portion is placed adjacent to the top of the window, light is restricted from leaking around the opaque cloth.

This invention can include a bottom portion carried by the opaque cloth so that when the bottom portion is placed adjacent to the window sill, light is restricted from leaking around the opaque cloth.

This invention can include a side portion carried by the opaque cloth so that when the side portion is placed adjacent to the window side, light is restricted from leaking around the opaque cloth.

This invention can include a third flexible securing member having a first end and a second end for securing the bottom of the opaque cloth into the window by placing the first end of the third flexible securing member against a first bottom corner of the opaque cloth and into a first bottom corner of the window and placing the second end of the third flexible securing member against a second bottom corner of the opaque cloth and into a second bottom corner of the window.

### DESCRIPTION OF THE DRAWINGS

The invention will be more readily understood from a reading of the following specification and by reference to the accompanying drawings forming a part thereof, wherein an example of the invention is shown and wherein:

FIG. 1 is a perspective view of the invention;

FIG. 2A is a front view of the invention;

FIG. 2B is a front view of the invention;

FIG. 2C is a front view of the invention;

FIG. 2D is a front view of the invention;

FIG. 3 is a view of the invention in a storage configuration;

FIG. 4 is a side view of an element of the invention;

FIG. 5 is a front view of a portion of the invention;

FIG. 6 is a front view of a portion of the invention; and

FIG. 7 is a perspective view of a portion of the invention.

### DESCRIPTION OF A PREFERRED EMBODIMENT

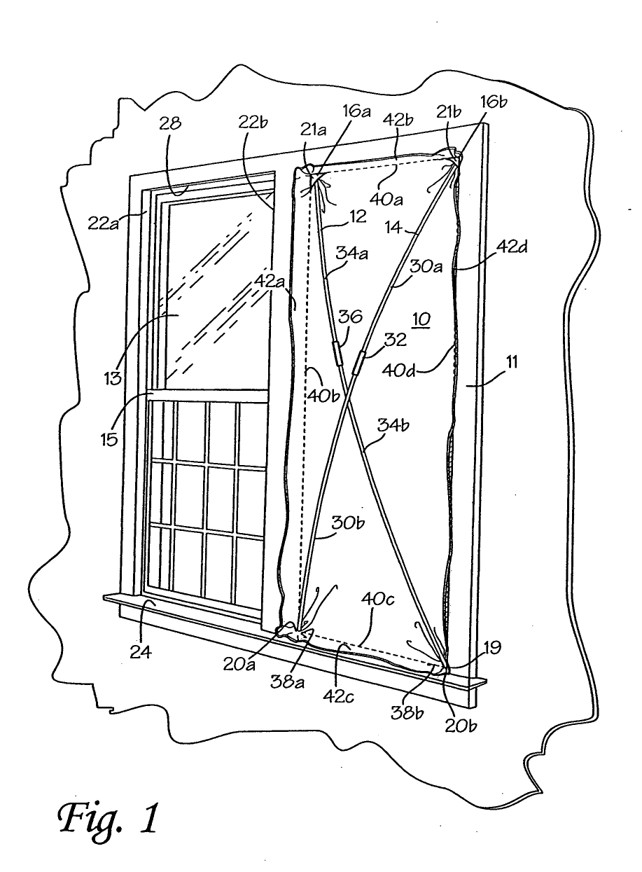

Referring to the drawings, the invention will be described in more detail. Referring to FIG. 1, an opaque cloth 10 is provided. This cloth can be what is known as “black-out” material or “black-out” cloth or fabric. The opaque cloth can be held in window 11 through a first flexible securing member 12 and a second flexible securing member 14.

In one embodiment, a first end of securing member 12 supports the opaque cloth by holding the opaque cloth into the top corner of the window. A second end of the first flexible securing member secures the bottom of the opaque cloth to the bottom corner of the window. Once in place, a top portion 42b of the opaque cloth is adjacent to a top portion 28 of the window. Side portions 42a and 42d of the opaque cloth are adjacent to a side 22a and 22b of the window. A bottom portion 42c of the opaque cloth is adjacent to window sill 24. With these top, side and bottom portions, light can be prevented from leaking around the opaque cloth when it is installed.

The outer portions of the opaque cloth can be formed with creases or folds in the opaque cloth to restrict light from leaking around the opaque cloth. The creases and folds are shown as 40a, 40b, 40c and 40d. These outer portions can also be sewn onto opaque cloth 10 or otherwise attached to the opaque cloth.

In one embodiment, the first flexible securing member can have a first portion 30a and a second portion 30b which can be connected by connector 32 so that the first flexible securing member is of sufficient length to secure the opaque cloth to the window. In one embodiment, the first securing member is positioned between a top corner 21a and a diagonally opposite corner 20b so that the first flexible securing member holds the opaque cloth in place with tension. Additionally, the first securing member 12 can have a first portion 34a and a second portion 34b which can be connected by a connector 36. The second flexible securing member can be placed in top corner 21b and diagonally opposite corner 20a. The second securing member can have a first portion 30a and a second portion 30b that can be joined by a connector 32. The first and second securing members can also be held in place by tension when the first and second flexible securing members have a length longer than the diagonal length of the window.

In one embodiment, pockets are carried by the opaque cloth to facilitate the installation of the flexible securing members. In this embodiment, one end of the first securing member is placed in a pocket 16b so that the top corner of the opaque cloth can be secured in the window. Further, one end of the second securing member is placed in a pocket 16a so that the other top corner of the opaque cloth can be secured in the window.

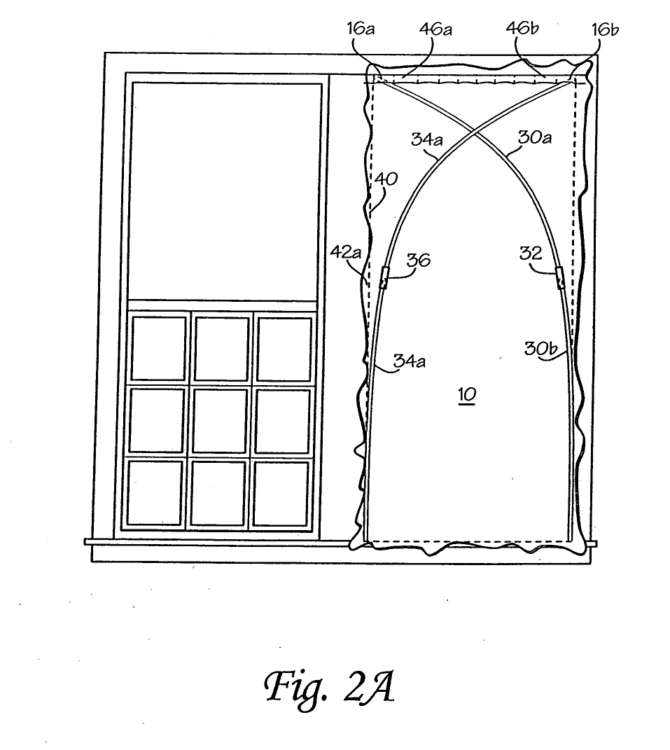

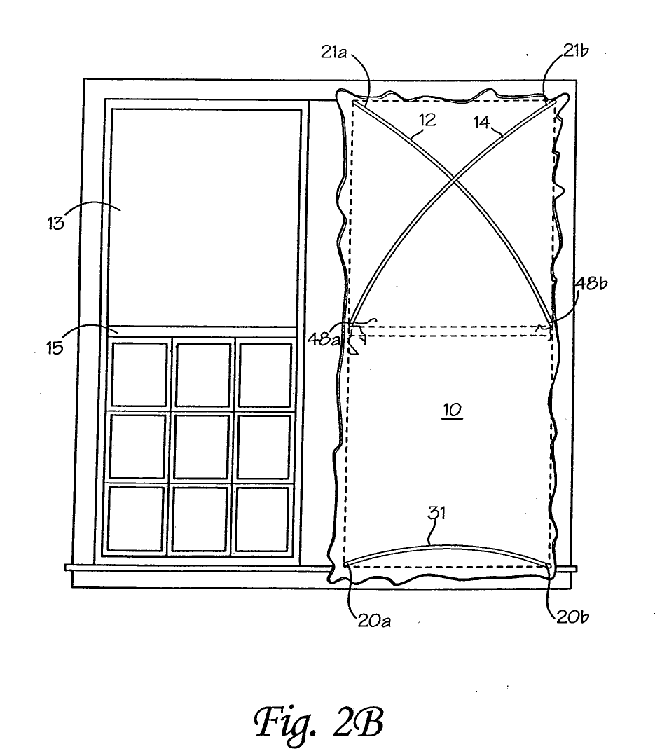

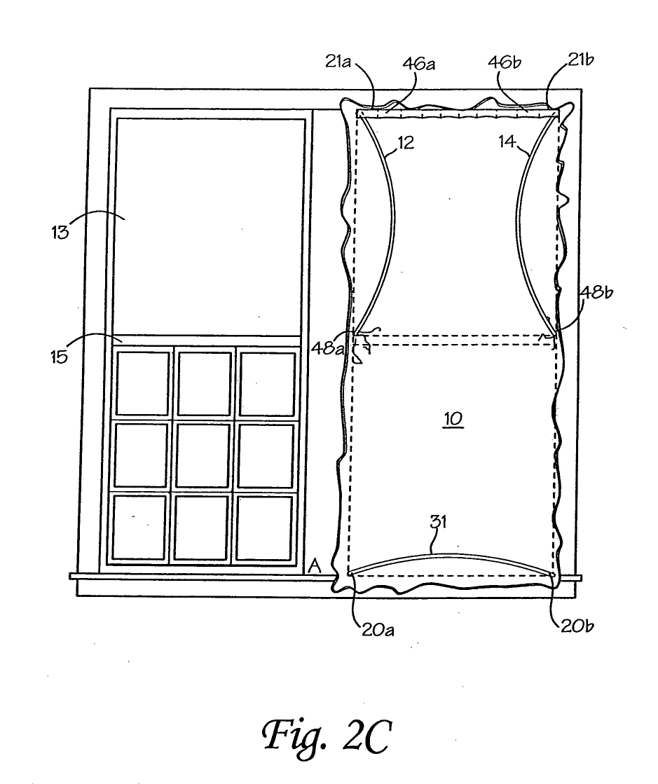

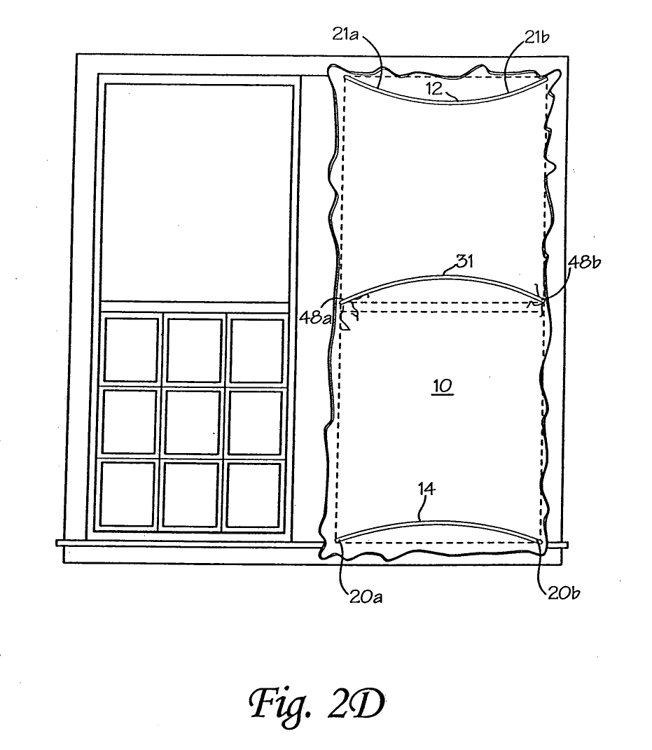

Referring now to FIG. 2A, an embodiment is shown. In this embodiment, pockets 16a and 16b are shown formed by seams 46a and 46b, respectively, to define pockets carried by the opaque cloth for receiving the flexible securing members. The first flexible securing member is shown with the first end securing the opaque cloth to the first top corner of the window and the second end of the first flexible securing member securing the opaque cloth to the second bottom corner of the window. The second flexible securing member is shown with the first end securing the opaque cloth to the second top corner of the window and the second end of the opaque cloth of the second flexible securing member securing the opaque cloth to the first bottom corner of the window.

Referring now to FIG. 2B, the preferred embodiment of the invention is shown. In this embodiment, a first side corner 48a and a second side corner 48b. In this embodiment, the first side corner and second side corner are formed where a first window sash 13 and a second window sash 15 overlap. This provides side corners to receive the second ends of the first and second flexible members, respectively. In this embodiment, the first flexible member is of a greater length than the distance from top corner 21a of the window and second side corner 48b so that tension holds the first flexible member in place. The second flexible member is also of a length greater than the diagonal length between the second top corner 21b of the window and the first bottom corner 48a of the window.

A third securing member 31 can be used to secure the bottom of the opaque cloth to the window. One end of the third flexible securing member is placed in bottom corner 20a while the other end is placed in bottom corner 20b. The third securing member can have a length greater than the distance between first bottom corner 20a and second bottom corner 20b so that it can be held in place by tension.

Referring now to FIG. 2C, another embodiment is shown. In this embodiment, first flexible securing member 12 secures the opaque cloth into the first top corner 21a of the window and the first side corner 48a of the window. The second flexible securing member 14 secures the opaque cloth into the second top corner 21b of the window and the second side corner 48b of the window.

Referring now to FIG. 2D, an embodiment is shown. First flexible securing member 12 secures the opaque cloth into first top corner 21a and second top corner of the window. The first flexible securing member can have a length greater than the distance between the first and second top corner of the window so that it is held in place by tension. The second flexible securing member can be placed between first bottom corner and second bottom corner to secure the opaque cloth to the window. The third flexible securing member can be placed between the side corners 48a and 48b to secure the opaque cloth to the sides of the window.

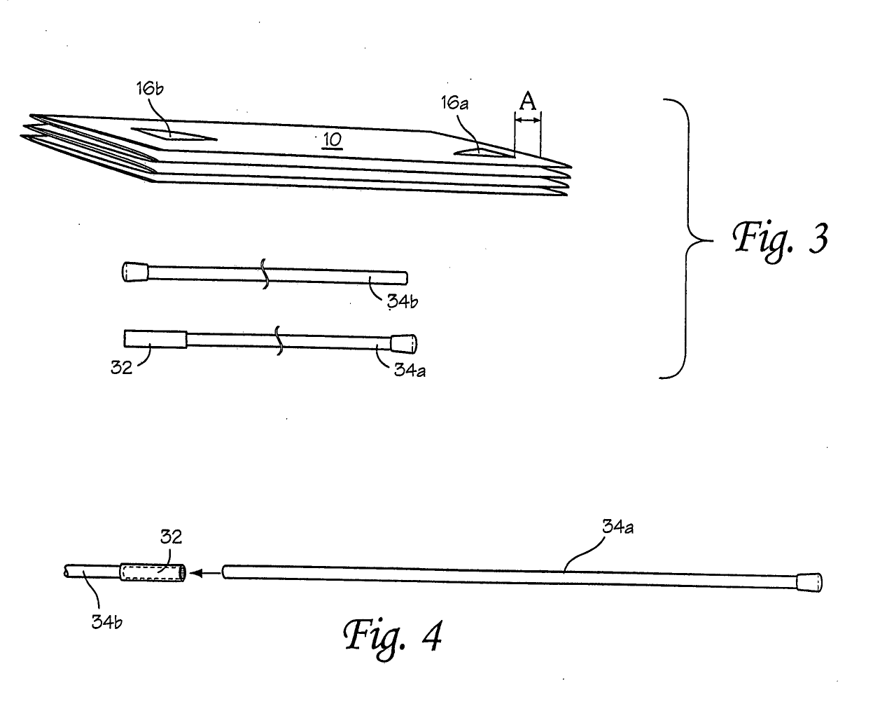

Referring now to FIG. 3, the invention is shown in a storage configuration with opaque cloth 10 folded and the flexible securing member disassembled. FIG. 4 illustrated first portion 34a disconnected from second portion 34b.

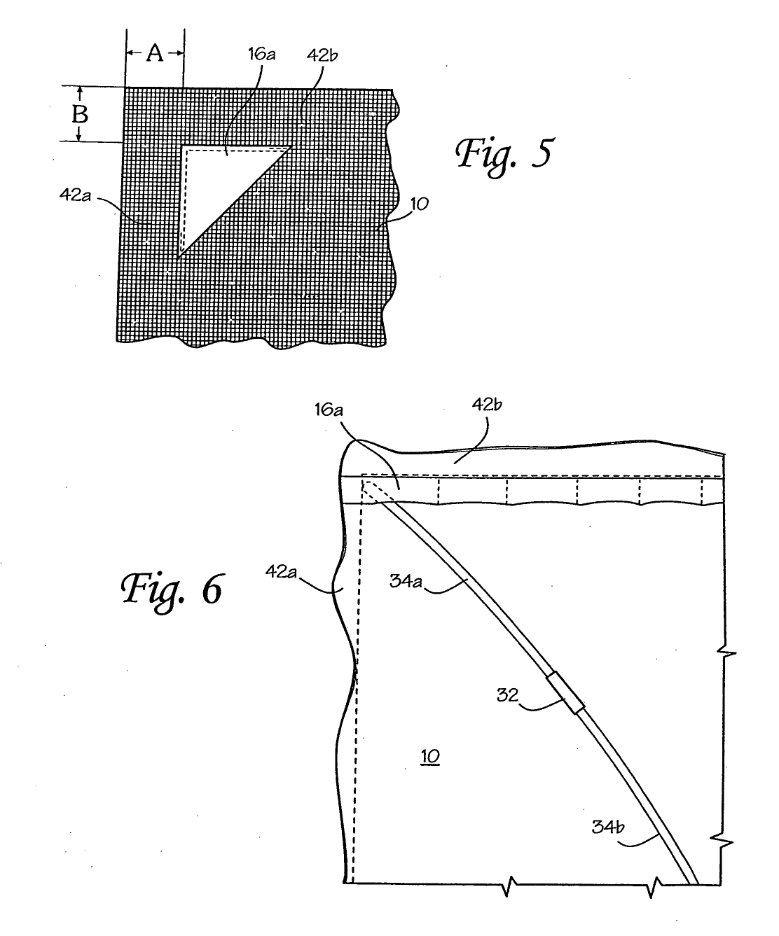

Referring now to FIG. 5, a portion of the opaque cloth 10 is shown with pocket 16a and portion 42a and 42b on the perimeter of the cloth.

Referring now to FIG. 6, a portion of the cloth is shown with the first flexible security member holding the corner of the opaque cloth through tension and being received by pocket 16a. Portion 42a of opaque cloth 10 can be adjacent to the window side of the window sill while top portion 42b is adjacent to the top of the window to prevent light from leaking around the opaque cloth.

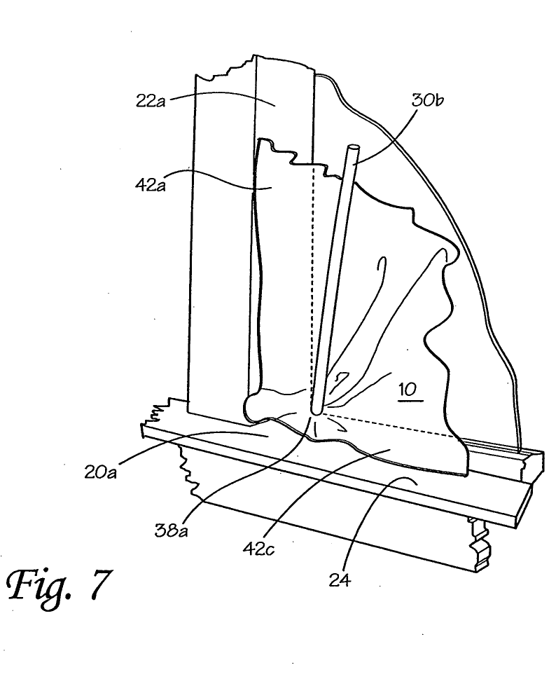

Referring now to FIG. 7, the opaque cloth is shown secured in place by second end 30b of the second flexible securing member. The second end of the second flexible security member holds the bottom corner of opaque cloth 10 in corner 20a with tension. This allows for side portion 42a to be adjacent to the window frame 22a and for the bottom portion of the opaque cloth 42c to be adjacent to window sill 24 to prevent light from leaking around the opaque cloth.

Using this invention, the opaque cloth is pressed into the top corners with the first securing and second securing members. This holds the cloth and allows the user to manipulate the flexible security members to force the corners of the opaque cloth into the corners of the windows. The other end of the flexible securing members are used to secure the corner of the cloth into the bottom of the corners of the windows by flexing the rods between the diagonal length of the window and forcing the opaque cloth to cover the window. The top, bottom and side portion of the opaque cloth can be adjusted so as to prevent light from leaking around the cloth.

In another embodiment, the first and second security members are used to hold the corners of the cloth in the top corners of the window while the opposite ends are used to hold the sides of the cloth in the corner formed by the first and second pane of the window. A third securing member is used to be placed in the bottom corners of the window and secure the corners of the cloth in the windows. In another embodiment, the first securing member is used to secure the top corners of the opaque cloth to the top corners of the window. The second securing member is used to secure the opaque cloth into the bottom corners of the window. The third securing member can be used to secure the opaque cloth to the side corners of the window. The side portions of the opaque cloth can be adjusted so as to prevent light from leaking around the opaque cloth.

While a preferred embodiment of the invention has been described using specific terms, such description is for illustrative purposes only, and it is to be understood that changes and variations may be made without departing from the spirit or scope of the following claims.

What is claimed is:

1. A method for restricting light from entering through a structure's window, with the window having a first and second top corner and a first and second bottom corner, comprising the steps of:
providing an opaque cloth having a length longer than the height of said window and a width larger than the width of said window, said opaque cloth having a first and second top corner and a first sand second bottom corner;
placing said first top corner of said opaque cloth into said first top corner of said window so that a portion of the perimeter of said opaque cloth is adjacent to a first side of said window thereby restricting light from leaking around said opaque cloth;
placing a first end of a first flexible securing member into said first top corner of said window so that said opaque cloth is secured into said first top corner of said window;
placing a second end of said first flexible securing member against a side of said window so that said opaque cloth is secured against said side of said window;
placing said first bottom corner of said opaque cloth into a first bottom corner of said window so that a portion of the perimeter of said opaque cloth is disposed adjacent to the sill of said window thereby restricting light from leaking around said opaque cloth;
placing a first end of a second flexible securing member into said first bottom corner of said window so that said opaque cloth is secured into said first bottom corner of said window; and,
placing a second end of said second bottom corner of said window so that said opaque cloth is secured into said second bottom corner of said window.

2. The method of claim 1 wherein the step of placing a second end of said first flexible securing member against said side of said window includes the step of placing said second end of said first flexible securing member into said second top corner of said window.

3. The method of claim 2 including:
placing a first end of a third flexible securing member against a first side of said window so that said opaque cloth is secured into said first side of said window; and,
placing a second end of said third flexible securing member against a second side included in said second top corner of said window so that said opaque cloth is secured against said second side of said window.

4. The method of claim 1 wherein the step of placing a second end of a first flexible securing member against said side includes the step of placing said second end of said first flexible securing member into a first side corner of said window.

5. The method of claim 1 wherein the step of:
providing an opaque cloth includes the step of providing an opaque cloth having a first pocket carried by said first top corner of said opaque cloth; and,
placing said first end of said first flexible securing member into said first pocket.

6. A light restricting apparatus for restricting light from entering a structure's window, with the window having a first and second top corner and a first and second bottom corner, comprising:
an opaque cloth having a length longer than the height of said window and a width larger than the width of said window, said opaque cloth having a first and second top corner and a first and second bottom corner;
a first flexible securing member for securing said first top corner of said opaque cloth in said first top corner of said window and for securing a first side of said opaque cloth to a first side of said window; and,
a second flexible securing member for securing said first bottom corner of said opaque cloth in said first bottom corner of said window and for securing said second bottom corner of said opaque cloth in said second bottom corner of said window.

7. The apparatus of claim 6 including a third flexible securing member for securing said second top corner of said opaque cloth in said second top corner of said window and for securing a second side of said opaque cloth to a second side of said window.

8. A light restricting apparatus for restricting light from entering a structure's window, with the window having a first and second top corner and a first and second bottom corner, comprising:
an opaque cloth having a length longer than the height of said window and a width larger than the width of said window, said opaque cloth having a first and second top corner and a first and second bottom corner;
a first flexible securing member for securing said first top corner of said opaque cloth in said first top corner of said window and for securing said second top corner of said opaque cloth to said second top corner of said window; and,
a second flexible securing member for securing said first bottom corner of said opaque cloth in said first bottom corner of said window and for securing said second bottom corner of said opaque cloth to said second bottom corner of said window.

9. The apparatus of claim 8 including a third flexible securing member for securing a first side of said opaque cloth against a first side of said window and for securing a second side of said opaque cloth against a second side of said window.
